(19) United States
(12) Patent Application Publication
(10) Pub. No.: US 2024/0291797 A1
(43) Pub. Date: Aug. 29, 2024

(54) MEDIA ACCESS CONTROL (MAC) ADDRESS ROTATION

(71) Applicant: Cox Communications, Inc., Atlanta, GA (US)

(72) Inventor: Carol Jeanette Ansley, Johns Creek, GA (US)

(73) Assignee: Cox Communications, Inc., Atlanta, GA (US)

(21) Appl. No.: 18/586,082

(22) Filed: Feb. 23, 2024

Related U.S. Application Data
(60) Provisional application No. 63/486,677, filed on Feb. 24, 2023.
(60) Provisional application No. 63/502,114, filed on May 14, 2023.
(60) Provisional application No. 63/512,919, filed on Jul. 11, 2023.

(51) Int. Cl. H04L 61/5038; H04L 101/622; H04W 8/26; H04W 84/12

(52) U.S. Cl. CPC H04L 61/5038; H04W 8/26; H04L 2101/622; H04W 84/12

(57) ABSTRACT

Media access control address rotation is provided. An access point associates with a station using a first media access control address. The access point receives an indication from the station that the station supports media access control address during association. The access point initiates the media access control address change. The access point receives a first upstream packet from the station using a second media access control address. The access point sends a first downstream packet to the station using the second media access control address.

### RELATED APPLICATION

Under provisions of 35 U.S.C. § 119(e), Applicant claims the benefit of U.S. Provisional Application No. 63/486,677, filed Feb. 24, 2023, U.S. Provisional Application No. 63/502,114, filed May 14, 2023, and U.S. Provisional Application No. 63/512,919, filed Jul. 11, 2023, each of which are incorporated herein by reference.

### BACKGROUND

Wireless networking includes the use of various computing devices to access services, including voice, audio, and video data services, over a wireless network such as a Local Area Network (LAN) of a home or business. Access Points (APs) can be used to provide Radio Frequency (RF) links or wireless channels for other radio-capable devices, such as smartphones, tablets, laptops, wearables, IoT, etc. to be able to access a Wide Area Network (WAN). When an AP and a device are in communication, that state is called association, and the AP and the device are said to be associated.

The Institute of Electrical and Electronics Engineers (IEEE) 802.11 standard defines protocols, procedures, and communication parameters to use for wireless networking, such as various Wi-Fi operational configurations. Current IEEE 802.11 standards require that a device or Station (STA) use the same Media Access Control (MAC) address for the length of its association with an AP. Some devices obscure their MAC addresses changing their MAC addresses randomly between associations. However, once associated with an AP, the associated device is required to maintain the same MAC address during the association. Otherwise, the device will be forced to re-associate each time it changes its MAC address.

Wi-Fi has had pressure from several fronts to improve its operational privacy. For example, MAC address information is readily available to surveil from unsuspecting device users once a device's wireless networking interface is activated. Data about the identity and movements of Wi-Fi device holders has been readily available because the initial design of Wi-Fi did not anticipate its use and the close linkage that could be extracted from a person's devices with a person's activities. One particular technical problem is that a device or STA uses its MAC address when it associates with an AP and thus can be identified or surveilled during the association.

Currently, third party snoopers can use different eavesdropping devices to collect MAC address information from Over The Air (OTA) traffic. A third party snooper can use collected MAC address information to determine where a device user may be located by monitoring an AP and MAC addresses that associate with the AP. A third party snooper may be able to determine the MAC address a device used when connected to an AP located at an office, hotel, home, etc. which may allow the third party snooper to track a location of a monitored device and/or applications being used based on an analysis of the frequency and the length of the packets. Captured MAC addresses can also be used for man in the middle attacks using a spoofing device to draw a user device to a certain AP.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Media Access Control (MAC) address rotation;

FIG. 2 is a flow chart of a method for MAC address rotation;

FIG. 3 is messaging diagram illustrating messaging operations between a station and an AP as part of MAC address rotation;

FIG. 4 is a diagram illustrating considerations on Multi-Link Operation (MLO) and MAC address rotation; and

FIG. 5 is a block diagram of a computing device.

### DETAILED DESCRIPTION

### Overview

Media access control address rotation is provided. An access point associates with a station using a first media access control address. The access point receives an indication from the station that the station supports media access control address during association. The access point initiates the media access control address change. The access point receives a first upstream packet from the station using a second media access control address. The access point sends a first downstream packet to the station using the second media access control address.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Aspects of the present disclosure provide mechanisms to hide, obscure, alter, limit, etc. an amount of information that is available to third parties when wireless devices communicate. In one example, MAC addresses and related parameters can be manipulated or modified so that an identity of a device communicating with an Access Point (AP) can be obscured or altered, in whole, or in part to provide an operational improvement to enhance data privacy. A client device or a Station (STA) with wireless networking capability may be configured to change its association MAC address without losing its association with a wireless gateway, AP, router, etc. Aspects disclosed herein provide techniques for Over-the-Air (OTA) MAC address changes while a STA, including a Multi-Link Device (MLD) and a non-MLD STA, is associated with an AP. Allowing Source Address (SA) and Destination Address (DA) MAC addresses to change at the same time or to change separately improves privacy of transmissions by making it more difficult to correlate or track Downstream (DS) and Upstream (US) transmissions to and from a STA.

In accordance with example embodiments, a STA may change its association MAC addresses without losing an association with a gateway, an AP, a router, etc. For STAs that are not equipped with Multi-Link Operation (MLO), for data frames while associated, the MAC address of a non-AP STA or an AP STA is used as a DA or as an SA of a data frame. As described herein, a transmission MAC address comprises a MAC address that is constructed for use in transmissions OTA as opposed to an actual MAC address built into each device.

In examples, a wireless device, such as a STA or AP for example, is configured with a MAC generation engine or an algorithm that operates to obscure, alter, or hide an identity (e.g., a MAC address manufactured with a wireless device) and/or behavior by using separate transmission MAC addresses for the DA and the SA. The transmission MAC addresses may be rotated simultaneously or separately. As one example, the AP and the STA can be configured to compute a list of MAC addresses using a MAC generation algorithm that generates pseudorandom MAC addresses in a definite sequence. Some algorithms may be preferred over others due in part to the use in other encryption or random character string generation facilities.

According to one aspect, for non-MLO capable devices, for data frames, the MAC address of a non-AP STA is used as the DA or as the SA of a frame. The MAC address of an AP STA is used similarly. The term “transmission MAC” can be used to indicate that the MAC address is constructed for use in transmissions OTA as opposed to the actual MAC address built into a STA. The term “MAC rotation” can be used to describe changing the transmission MAC addresses for wireless communication (e.g., Wi-Fi) units/devices, such as non-AP STAs and AP STAs.

According to an aspect, an identity of STAs and their behavior may be obscured by using separate transmission MAC addresses for DA and SA. These addresses may be rotated simultaneously or separately. Using a non-AP STA as an example, the AP and the STA can use a MAC generation algorithm to generate pseudorandom MAC addresses in a definite or deterministic sequence. Some algorithms may be preferred over others due to the use in other encryption or random character string generation facilities within the protocol stack for 802.11 devices. The AP and the STA can be configured to operate with a common assumption of the values for insertion into the algorithm to produce a deterministic result for both sides.

One example MAC generation algorithm follows:

$$@ PairMAC ( n + 1 ) = PRF - 128 / 46 ( KEY , “ PairMAC ” , @ PairMAC ( n ) , 128 )$$

where PRF-128/46( ) is an algorithm for producing randomized output from a given set of input strings, and the KEY may be the current Pairwise Master Key (PMK) used between a STA and the AP. There are many other shared keys available to the AP and its associated STA. In some instantiations, the KEY may be an existing shared key to limit the additional processing for this feature. Some examples are a PMK, a Key Encryption Key (KEK), or a Temporal Key (TK). The KEY may be an entirely new key or one that is derived from an existing shared key. The leftmost 46 bits are selected for the SA MAC used to transmit from the STA. The next 46 bits are selected for the DA MAC used for traffic to the same STA.

Another example MAC generation algorithm may follow:

$$@ SMAC ( n + 1 ) = PRF - 128 / 46 ( KEY , “ SMAC ” , @ SMAC ( n ) , 128 ) \\ @ DMAC ( n + 1 ) = PRF - 128 / 46 ( KEY , “ DMAC ” , @ DMAC ( n ) , 128 )$$

where the KEY may be the current PMK. The leftmost 46 bits are selected for each MAC (SMAC to mark traffic transmitted from the STA, and the DMAC used to mark traffic transmitted to the same STA).

The approach of decoupling the SA and the DA may cause changes in the AP and the STA since the same MAC address would no longer be used for both fields. This might result in an increase in memory usage since the algorithms to track the SA and the DA usage may be decoupled. But, it would also make it much more challenging to track the activity of an individual STA, particularly when it was active within an AP with many other STAs passing traffic up and down over the wireless medium.

According to another aspect, an identity of one or more STAs can be obscured while associated by allowing a STA, which can be an AP STA or a non-AP STA, to direct a change in the MAC address or MAC addresses used. A protected action frame can be used to indicate which address or addresses would be changed and provide an indicator of when the change would take place. A new frame can be defined as a MAC rotation transition frame. The transition from one MAC address or set of MAC addresses to another may take place after a certain number of frames. For example, if a STA had 5 frames in its outgoing buffer, it might indicate that it will change to a new SA in 5 frames. Alternatively, a STA might indicate an amount of time in microseconds or milliseconds until the change would take effect. In yet another alternative, a STA might indicate a certain number of Beacon frames before the transition would take effect.

To reduce the degree of correlation between a particular STA's transmissions, a desirable system may allow all of the STAs to shift their MAC addresses at the same time, for example, by setting a timer in microseconds or milliseconds. Due to the challenges in getting a potentially large number of STAs sufficiently synchronized, an AP may update groups of STAs. When an AP notifies a group of STAs of the upcoming changes, the AP may use a Block Acknowledgement (BA) to receive acknowledgements from the STAs in the group to ensure that all of them are ready. Alternatively, the AP may rely upon receiving individual responses from the STAs. If a STA does not respond, or responds negatively, the AP may continue with the update for the other STAs that indicated their acceptance.

Alternatively, the AP may cancel the upcoming changes. A separate protected action frame may be used to cancel an upcoming MAC change sequence. However, a single STA refusing to change may reduce the privacy of a number of other STAs if the AP cancelled the change if less than all STAs responded. Additionally, the cancellation command may also be problematic if a STA received and acknowledged the command, then went into a power saving state until the changeover time, it might end up on a set of MAC addresses that the AP did not expect.

According to an aspect, OTA MAC address change coordination may include a STA indicating to other STAs that it can support a MAC address change while associated by setting a field that could be named the Enhanced Data Privacy (EDP) Active to 1. This field may be added to the Extended Capabilities field and communicated in one of the beacon frames, the Probe request/response frames, and other frames. A STA can avoid OTA MAC change while associated by not including that field or setting it to 0. For instance, if a STA cannot support a transition, it may clear the field until it can support such a transition. If an AP STA sets the field to 1, then any associated STAs that also support this feature may be prepared for a transition to begin unless they have not set their EDP field to 1. If an AP has only one STA with EDP active, the AP may choose to put off changing OTA MAC addresses until there are at least a predetermined number of STAs (for example, two) supporting the feature.

In the Beacon frame, an additional field may be added for STA coordination defined as the OTA MAC Rotation Count field. If a STA has been dozing or lost communication briefly or suffered a restart, thus missing an OTA MAC address change, it can discover that it is out of sync with the AP by checking the OTA MAC Rotation Count field in the Beacon frame. Each time the PMK is changed or reinitialized, the OTA MAC Rotation Count field can be cleared back to 0 or some other known value. Each time an OTA MAC rotation is executed, the counter can be incremented. Since the sequence of MAC addresses linked to a STA is fixed once the PMK and starting STA MAC address is known, a STA can check or consult the OTA MAC Rotation Count field to find out how many iterations of the MAC address generation utility must be run to get back in sync with the AP. For example, if the STA last knew that the OTA MAC Rotation Count field was at 501 and then sees the field is at 503, it knows that it must take the OTA MAC information from instance 501 and iterate the OTA MAC generation algorithm twice to get back in sync with the AP.

According to yet another aspect, MAC address changes may require synchronized changes to other values generally in the Physical (PHY) layer sections of frames, such as the frame Sequence Number (SN) and the seed for an Orthogonal Frequency-Division Multiplexing (OFDM) PHY scrambler. For a single STA seeking to change its MAC address for the SA or the DA, the protected action frame may be configured to contain the new SN and the new scrambler seed or an indication to the AP of how to compute them. If the AP is directing a change to all of its subtending STAs, it may choose to provide a single new scrambler seed and a single new SN for all the STAs to use after the switchover timer expires. The STAs might use the numbers directly, since an observer may not be able to connect a STA's packets with the new settings to its previous ones. The observer may still be able to guess from a pattern of packet transmissions, but it may require more work on the part of the observer.

An AP may provide a seed for each STA to use separately to reset PHY parameters, again using an algorithm that may be selected from a predetermined set of algorithms that provide pseudorandom results from each new input parameter collection. This approach may obfuscate the behavior of STAs to a new observer who did not observe the switchover of the PHY parameters. The simplicity of sending a single value set might outweigh such improvement. If a STA is in power down state, the AP may set the transition timer for the MAC changes to happen after the STA has had time to wake up and receive the information about the upcoming MAC changes. Alternatively, the AP may coordinate a selected group of STAs to change, then wait to notify another set of STAs to change.

MLO within IEEE 802.11 and MAC address rotation during association is also provided. For MLO, more MAC addresses may be considered since there is a MAC address for the MLD as well as MAC addresses for each of the subtending links. For an MLD, there are multiple affiliated devices as its components. For example, an AP MLD has several affiliated APs that each contribute one link. Each non-AP MLD similarly has several affiliated STAs that each contribute one link.

According to an aspect, for MAC address rotation on MLDs, the procedure may take into account that the individual links use link-specific MAC addresses, while at the MLD's upper MAC, sequence numbers and packet numbers (PNs) are inserted. To change the MAC addresses without also shifting the SN/PNs may allow an observer to still associate a particular set of packets with a particular MAC. To ensure a clean transition using the current uniform increment for SN/PN, all queues for a flow Traffic Identifier (TID) may be emptied before the new MACs and PN/SNs can be used. Alternatively, the obfuscation procedure of the SN/PN may be separate from the MAC change procedure. Specifically, instead of the SN incrementing smoothly by one with each frame, the sequence number may be a pseudorandom value that is derived from a deterministic sequence. Many deterministic sequences may be used to determine the pseudorandom value, for example, the digits of pi or the Fibonacci sequence. One requirement for determining the pseudorandom value may be that the sequence must not repeat within some set number of instances so that adjacent packets can be distinguished from each other, and so that a lost packet is easily recognized. For example,

$$@ SN ( n + 1 ) = PRF - 128 / 46 ( KEY , “ sequence ” , @ SN ( n ) , 128 )$$

where the KEY is a shared key between the AP and the STA, and the leftmost 12 bits are used for the OTA sequence number. Using a randomized sequence number would allow each affiliated AP to manage its OTA MAC rotation independently.

Changing the MAC addresses of one or more STAs associated with an AP (or an AP affiliated with an AP MLD) may likely cause at least some delay or disruption. Therefore, a frequency with which an AP may perform the MAC address rotation may be governed by case-specific rules. For example, if an AP has only one STA, the utility of rotating MAC addresses may be small. As the number of STAs increases, however, the potential obfuscation offered by the MAC rotation increases. The value to a single STA is that a third party observer may or may not be able to determine if the messages sent using the new MAC from a new STA or the original STA without further investigation. When there are many STAs, simultaneous changes can serve to obfuscate identifying traffic patterns within the group of STAs.

Another approach may include having several MAC addresses associated with each STA for use as SAs or DAs. If the STA randomly chooses from among those SAs as it sends traffic to the AP, the probability of an observer connecting the different MACs to the same STA would be reduced. This change, while increasing privacy, may also pose a greater challenge to the device vendors as it is a greater change from the current MAC address usage address framework. In addition, the AP may need to associate several SA MAC addresses to the same STA. The AP may also use several DA MAC addresses that all may be accepted by the same STA as referring to it. In examples, the MAC address generation algorithm may be extensible to DMG, CDMG, Mesh and SIG. As the management frames are already proposed to be encrypted, privacy improvements may not need to alter the AID field.

As described above, MLO communication environments may include an AP MLD and one or more STA MLDs. Affiliated APs are part of the AP MLD which are managing MAC addresses for each link. An MLO communication environment can also use an external MAC address for group messages and broadcasting events. An advantageous way to change the MAC addresses while everything is set up and associated, is for all of the affiliated APs and their associated STAs to change all OTA MAC addresses with a single coordinated change. Alternatively, each affiliated AP can independently coordinate MAC address changes with their associated STAs.

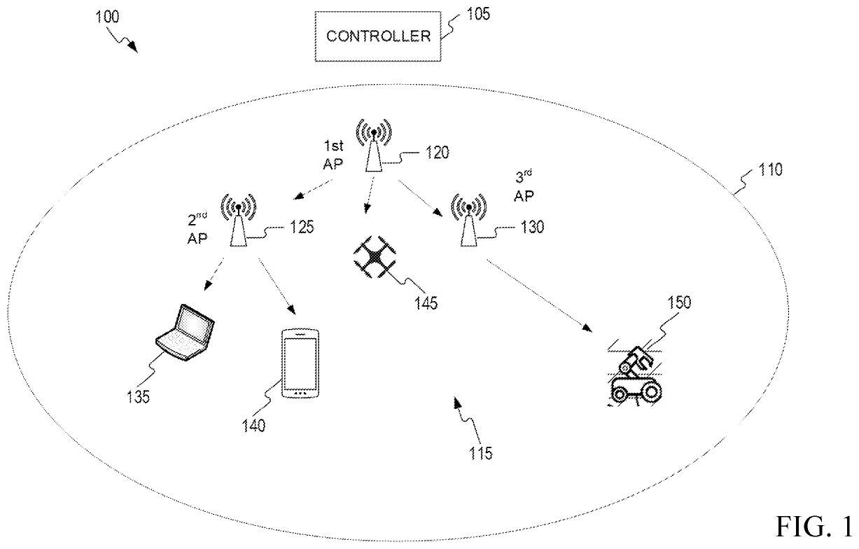

FIG. 1 shows an operating environment 100 for MAC address rotation. As shown in FIG. 1, operating environment 100 may comprise a controller 105 and a coverage environment 110. Coverage environment 110 may comprise, but is not limited to, a Wireless Local Area Network (WLAN) comprising a plurality of STAs 115. Plurality of STAs 115 may include a plurality of APs and a plurality of client devices. At any given time, any one of the plurality of STAs 115 may comprise an Initiating Station (ISTA) or a Responding Station (RSTA). The plurality of APs may provide wireless network access (e.g., access to the WLAN) for the plurality of client devices. The plurality of APs may comprise a first AP 120, a second AP 125, and a third AP 130. Each of the plurality of APs may be compatible with specification standards such as, but not limited to, the Institute of Electrical and Electronics Engineers (IEEE) 802.11 specification standard for example.

Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, an Unmanned Aerial Vehicle (UAV), or other similar microcomputer-based device. In the example shown in FIG. 1, the plurality of client devices may comprise a first client device 135 (e.g., a laptop computer), a second client device 140 (e.g., a smart phone), a third client device 145 (e.g., a drone), and a fourth client device 150 (e.g., an ATV).

Controller 105 may comprise a Wireless Local Area Network controller (WLC) and may provision and control operating environment 100 (e.g., the WLAN). In some embodiments of the disclosure, controller 105 may configure information for operating environment 100 in order to provide MAC address rotation consistent with embodiments of the disclosure.

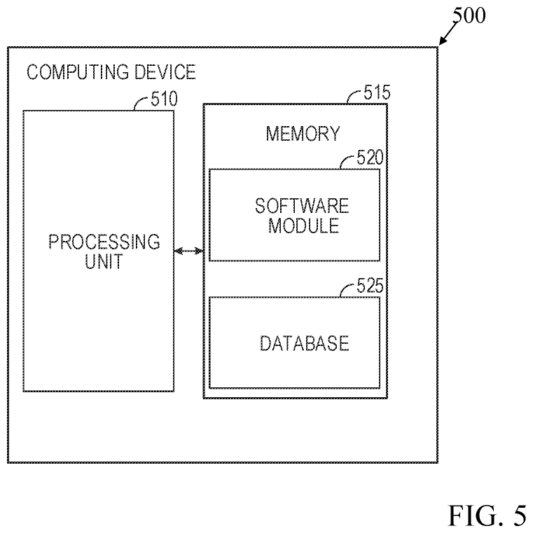

The elements described above of operating environment 100 (e.g., controller 105, first AP 120, second AP 125, third AP 130, first client device 135, second client device 140, third client device 145, and fourth client device 150) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 5, the elements of operating environment 100 may be practiced in a computing device 500.

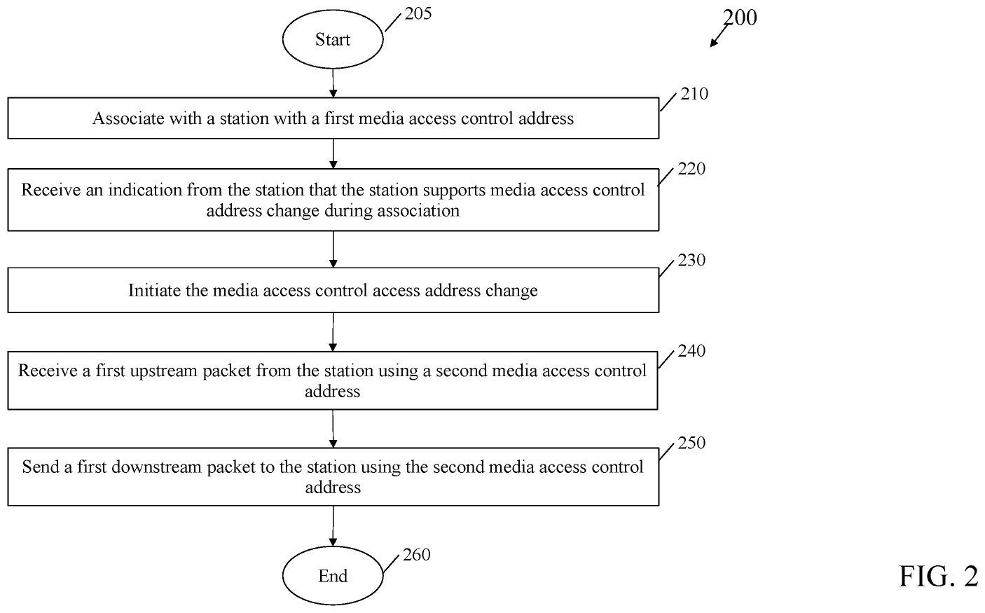

FIG. 2 is a flow chart setting forth the general stages involved in a method 200 consistent with embodiments of the disclosure for MAC address rotation. Method 200 may be implemented using first AP 120 that may be embodied by a computing device 500 as described in more detail below with respect to FIG. 5. However, method 200 may be implemented using any of controller 105 or plurality of STAs 115. Ways to implement the stages of method 200 will be described in greater detail below.

Method 200 may begin at starting block 205 and proceed to stage 210 where first AP 120 may associate with a STA (for example, first client device 135) using a first MAC address. In examples, first AP 120 may associate with first client device 135 through exchange of a plurality of association messages.

Once first AP 120 associates with the STA (that is, first client device 135) at stage 210, method 200 proceeds to stage 220 where first AP 120 receives an indication from the STA (that is, first client device 135) that the STA supports MAC address change during association. As discussed above, the indication that first client device 135 supports MAC address change during association may be provided by first client device 135 by setting a capability field value to 1, where the capability field indicates support for the MAC address change. The capability field could be named the EDP Active field. Such a field can be exchanged in a Beacon frame, a Probe response frame, or any frame supporting a capabilities field element, such as an Extended RSN Capabilities field. In some examples, first client device 135 can avoid the MAC change while being associated with first AP 120 by not including such a support indication bit or setting it to 0. For instance, if first client device 135 cannot support a transition, it can clear the capability field bit until it can support such a transition. If an AP STA indicates that it also supports the MAC change capability, then any associated STAs supporting this feature may be prepared for a transition to begin unless they have not indicated support for the MAC address change.

After first AP 120 receives an indication from the STA (that is, first client device 135) that the STA supports MAC address change during association at stage 220, method 200 proceeds to stage 230 where first AP 120 initiates the MAC address change. Each of plurality of stations 115, including first AP 120 and first client device 135, is provided with a MAC address generation engine or a MAC address generation algorithm. As discussed above, the MAC generation engine or algorithm operates to generate new MAC addresses for OTA transmission of data or control packets. Separate transmission MAC addresses may be generated for the DA and the SA. The DA and the SA addresses may be rotated simultaneously or separately. As one example, first AP 120 and first client device 135 may be configured to compute a list of MAC addresses using a MAC generation algorithm that generates pseudorandom MAC addresses in a definite sequence. Some algorithms may be preferred over others due in part to the use in other encryption or random character string generation facilities.

Having initiated the MAC address change at stage 230, method 200 proceeds to stage 240 where first AP 120 receives a first upstream packet from the STA (that is, first client device 135) using a second MAC address. As discussed above, different MAC address may be used for the upstream and downstream traffic. In addition, after a predetermined number of packets of the first upstream traffic, a second new source MAC address may be used to send a next predetermined number of packets of the upstream traffic, and so on.

After first AP 120 receives the first upstream traffic from the STA (that is, first client device 135) using the second MAC address at stage 240, method 200 proceeds to stage 250 where first AP 120 sends a first downstream packet to the STA (that is, first client device 135) using the second MAC address. In addition, after a predetermined number of packets of the first downstream traffic, a second new destination MAC address may be used to send a next predetermined number of packets of the first downstream traffic, and so on. Method 200 may terminate at stage 260. Note that in different instantiations, step 240 may precede step 250 or step 250 may precede step 240.

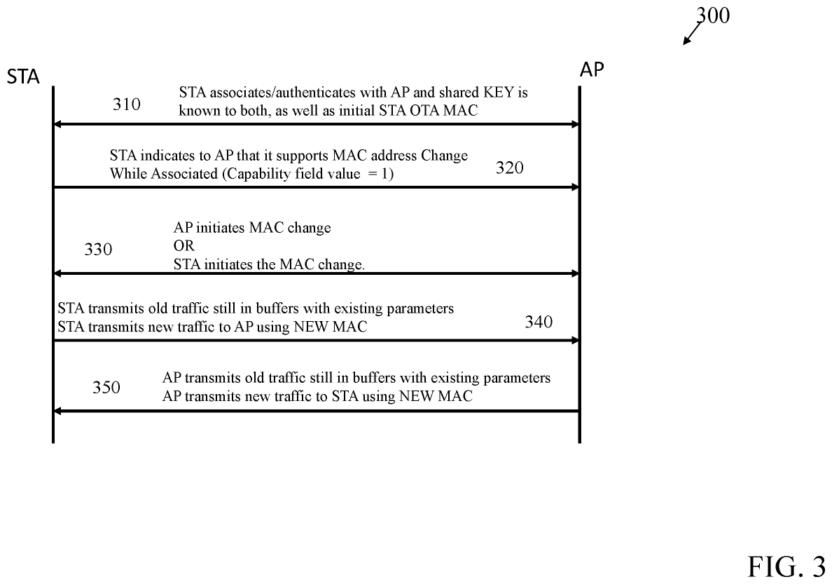

FIG. 3 is a messaging diagram 300 that illustrates an aspect for messaging operations between a STA (for example, first client device 135) and an AP (for example, first AP 120) as part of changing one or more MAC addresses while associated without losing the association. In FIG. 1, SMAC1 refers to a first randomized SA MAC address and DMAC1 refers to a first randomized DA MAC address.

At operation 310, a STA (for example, first client device 135) associates/authenticates with an AP (for example, first AP 120). A shared Key is exchanged, and therefore known to both. An initial STA OTA MAC (OLDMAC) is used during this process as well as capability fields to indicate that the MAC address change during association is supported by the associating STA and the AP

At operation 320, the STA (that is, first client device 135), once associated, may indicate to the AP (that is, first AP 120) that it supports the MAC address change or rotation while being associated. The STA may also indicate other parameters associated with the MAC address change, such as a preference for an interval between changes, a preferred MAC address space, or other related parameters. As discussed above, the indication may be provided through appropriate settings in a capability field. The capability field may be a Beacon frame, a Probe response frame, or a STA capabilities frame, such as thee Extended RSN field. In some examples, first client device 135 can avoid the MAC change while associated by an appropriate capability indication for the MAC address change or setting that indication to inactive. For instance, if first client device 135 cannot support a transition, it can set that indication to inactive until it can support such a transition. If an AP STA indicates that it supports MCA address change, then any associated STAs that also support this feature may be prepared for a transition to begin unless they have not indicated a support for the MAC address change.

At operation 330, the AP (that is, first AP 120) initiates the MAC change. First AP 120 may initiate the MAC change by incrementing a MAC Change Count field. In some examples, the station (that is, first client device 135) may also initiate the MAC change. Alternatively, the AP may send an Action frame to the STA or STA targeted for MAC address change. In still other instantiations, the STA may send an Action frame to the AP requesting a MAC address change.

At operation 340, the STA (that is, first client device 135) transmits old traffic still in buffers with existing parameters (including the association MAC address and the Sequence Numbers (SN) and Packet Numbers (PN) as appropriate). The STA (that is, first client device 135) transmits new traffic to AP using the new MAC address and the other associated new parameters, such as SN and PN as appropriate.

At operation 350, the AP (that is, first AP 120) transmits old traffic still in buffers with existing parameters (including the association MAC address and the sequence numbers (SN) and packet numbers (PN) as appropriate). The AP (that is, first AP 120) transmits new traffic to the STA (that is, first client device 135) using the new MAC address and other associated parameters as appropriate. Both the STA (that is, first client device 135) and first AP 120 may track their buffers to decide when the initial association MAC address can be discarded using a dual set of buffers. In some examples, the STA (that is, first client device 135) is notified or it determines that a transition interval has begun. Any new packets arriving at the STA (that is, first client device 135) for transmission are queued to use the new parameter set including MAC, SN, AID, etc. in a new set of packet queues. Processing of incoming packets from the wireless medium is expanded to include old and new MACs, with related new parameter set.

Existing packets in transmit buffers already constructed using the association MAC address and other old parameters may be queued for transmission as is. Any retransmissions may continue to use the existing packets. The STA (that is, first client device 135) tracks emptying of old packets and may send a protected action frame when all old packets are emptied out of the old queues. Once the old buffers are empty, they may be available for the next transition as new buffers.

As discussed above, allowing SA MAC address and DA MAC address to change separately improves the privacy of transmissions by making it more difficult to correlate the DS and the US transmissions to a STA. Using a capabilities field indicating support or not for this feature may allow STAs to indicate and to determine which devices support MAC address rotation during association. Using an OTA MAC address Change Count field in a Beacon frame can allow STAs to ensure synchronization with the AP. The change Count field may include one byte or more than one byte. For MLDs, changing the increment used for sequence numbers and packet numbers would simplify the ability to change OTA MAC addresses.

According to disclosed aspects, certain considerations are taken into account when changing a STA's OTA MAC address, such as while associated with an AP. For example, IEEE 802.11bi defines a mechanism for a Client Privacy Enhancements (CPE) Client to change its own OTA MAC address when reassociating from a CPE AP to another CPE AP. According to an aspect, a CPE Client can be configured to initiate changing its own OTA MAC address used with a CPE AP in Associate STA State 4 without any loss of connection. A CPE AP can be configured to initiate changing the OTA MAC addresses of a set of associated CPE Client's in the basic service set (BSS) (e.g., CPE Clients in Associate STA State 4) without any loss of connection. A CPE Client and a CPE AP can be configured to establish the CPE Client's DS MAC address without the CPE Client's DS MAC address being transmitted in the clear. A BSS Privacy Enhancements (BPE) AP and a BPE Client can be configured to change the OTA MAC addresses, SNs, and PNs they use for unicast transmissions.

According to an aspect, separate unrelated random OTA MAC addresses can be used for SA and DA values for a STA. MAC addresses can be defined from the perspective of the STA, wherein SMAC is used by the STA for its outgoing transmissions and DMAC is used by the STA to set up its receive address filtering. From the perspective of the AP (assuming the STA is a non-AP STA), the DMAC is used for its transmissions to the STA, and the SMAC is used to identify transmissions from that STA. An advantage follows that using unrelated values for DA and SA obscures the relationship between DS and US traffic when there is more than one STA associated to an AP. However, device design has assumed for a long time that the DA and SA are the same value which may lead to some engineering challenges in device and/or communication protocols.

According to an aspect, a MAC address generation algorithm can be configured as follows:

$$@ MAC ( n + 1 ) = PRF - 128 / 46 ( ERCM Key , “ ERCM ” , @ MAC ( n ) , 128 )$$

where the ERCM key is passed in a separate action frame exchange, and the leftmost 46 bits are selected. However, since a variety of shared keys, such as a PMK, are already available, the MAC address generation algorithm can be configured as:

$$@ PairMAC ( n + 1 ) = PRF - 128 / 46 ( KEY , “ PairMAC ” , @ PairMAC ( n ) , 128 )$$

where the KEY is a key shared between the AP and an associated non-AP STA such as the current Pairwise Master Key. The leftmost 46 bits are selected for SA MAC used to TX from a non-AP STA and the next 46 bits are selected for the DA MAC used for traffic to the same non-AP STA.

Alternatively, the MAC address generation algorithm can be configured as:

$$@ SMAC ( n + 1 ) = PRF - 128 / 46 ( KEY , “ SMAC ” , @ SMAC ( n ) , 128 ) \\ @ DMAC ( n + 1 ) = PRF - 128 / 46 ( KEY , “ DMAC ” , @ DMAC ( n ) , 128 )$$

where the KEY may be the current PMK. The leftmost 46 bits are selected for each MAC (SMAC to mark traffic TX from a non-AP STA, and a DMAC is used to mark traffic TX to the same non-AP STA). Using an existing key may avoid additional messaging exchanges which may reduce latency and communication overhead. Changing the SA and the DA MACs separately removes the linkage between DS and US traffic.

According to an aspect, an STA can be configured to indicate to other STAs that it can support a MAC address change while associated with an appropriate value on a capabilities field. A STA can avoid OTA MAC address change while associated by not including the capabilities field or configuring it to indication that It does not currently supports the MAC address change. For instance, if a STA cannot support a transition, it may indicate that in its capabilities field until it can support such a transition. If an AP STA indicates supports the MAC address change, then any associated STAs that also support this feature should be prepared for a transition to begin unless indicate a lack of support. If an AP has only one STA with that supports the MAC address change, the AP may choose to put off changing the MAC address until there are at least two STAs supporting the feature.

According to an aspect, to allow for a STA to synchronize its OTA MAC addresses with an AP, a new field in a Beacon frame can be configured as the OTA MAC Rotation Count field. If a STA has been dozing or lost communication briefly or suffered a restart, thus missing an OTA MAC address change, the STA can discover that it is out of sync with the AP by checking the OTA MAC Rotation Count field in the Beacon frame. Each time the PMK is changed or reinitialized, the OTA MAC Rotation Count field may be cleared. In addition, each time an OTA MAC rotation is executed, the counter is incremented. According to one aspect, the sequence of MAC addresses linked to a STA is fixed once the PMK and starting MAC address is known so that a STA can consult the OTA MAC Rotation Count field to find out how many iterations of the MAC address generation utility to be run to get back in sync with the AP. For example, if the STA last knew that the OTA MAC Rotation Count field was at 501 and then sees the field is at 503, it knows to take the OTA MAC information from instance 501 and iterate the OTA MAC generation algorithm twice to get back in sync with the AP, assuming that the PMK is unchanged.

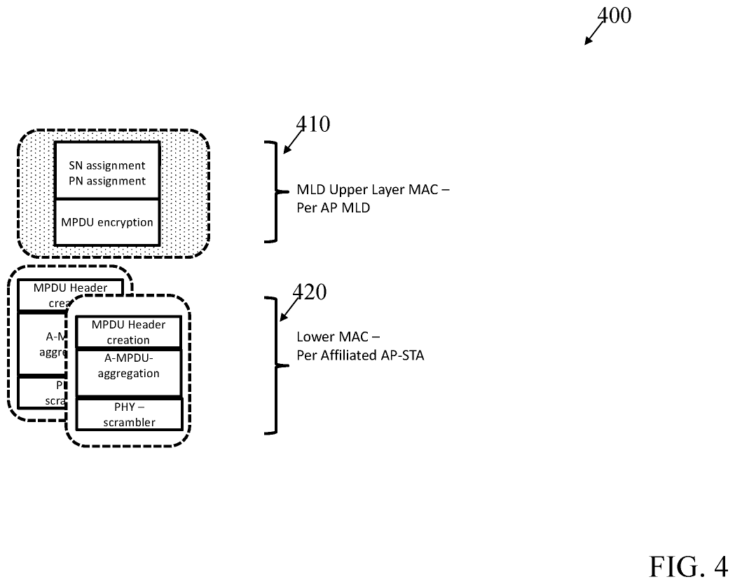

FIG. 4 is a diagram 400 that illustrates considerations on MLO and MAC address changes. As shown in FIG. 4, since individual affiliated STAs use their own MAC addresses, a MAC address transition event within an MLD may be able to proceed within each affiliated AP independently, shown as (420). According to an aspect, an AP MLD can be configured to set the SN/PN for each flow, shown as (410). As a result, even if the affiliated STAs all change their addresses, the new address may be linked to the old one by the SN/PN unless that is changed as well.

According to another aspect, a mechanism to enable an MLD OTA MAC address rotation or change during association can be provided. Because the SN/PN are changed at the upper MAC level of an AP MLD (, shown as (410)), all the queues across the entire MLD can be flushed to ensure a safe transition. However, this could cause an unreasonable amount of delay for some packets/flows if one or more of the links either have excessive traffic or large amounts of retransmissions. In some examples, the scheme for incrementing SN/PN may be changed to use a random increment so that the sequence may not be simple to link between before and after the OTA MAC addresses changed.

For example,

$$@ SN ( n + 1 ) = PRF - 128 / 46 ( KEY , “ sequence ” , @ SN ( n ) , 128 )$$

where the KEY is a shared key, such as the current PMK and the leftmost 12 bits are used for the OTA sequence number. Using a randomized sequence number enables each affiliated AP to manage its OTA MAC rotation independently.

According to an aspect, MAC address generation for MLDs can be provided. For example, within an MLD the same PMK can be used for all of the links, but each link uses a separate MAC address in its unicast transmissions. Since a single PMK is available, the following can be used for MLO:

$$@ PairMAC ( n + 1 ) = PRF - 128 / 46 ( KEY , “ concatenate ( “ PairMAC ” , STA - MAC ) , \\ @ PairMAC ( n ) , 128 )$$

where the KEY is a shared key, such as the current PMK and the text string is a concatenation of the affiliated STA for that link's original MAC address and the string “PairMAC.” The leftmost 46 bits are selected for SA MAC used to TX from an affiliated non-AP STA. The next 46 bits are selected for the DA MAC used for traffic to the same affiliated non-AP STA.

In some other examples, the following can be used for MLO:

$$@ SMAC ( n + 1 ) = PRF - 128 / 46 ( KEY , concatenate ( “ SMAC ” , STA - MAC ) , \\ @ SMAC ( n ) , 128 ) \\ @ DMAC ( n + 1 ) = PRF - 128 / 46 ( KEY , concatenate ( “ DMAC ” , STA - MAC ) , \\ @ DMAC ( n ) , 128 )$$

where the KEY is a shared key, such as the current PMK used for the AP-MLD and the text string is a concatenation of the affiliated STA for that link's original MAC address and the string “SMAC” or “DMAC.” The leftmost 46 bits are selected for each MAC (SMAC to mark traffic TX from a non-AP STA, DMAC used to mark traffic TX to the same non-AP STA).

Using an existing key avoids additional messaging exchanges. Moreover, changing the SA and DA MACs separately removes the linkage between DS and US traffic. In some examples, the SNs and PNs for at least MLDs from +1 to +/−random amount, subject only to a lack of repeat numbers within 10 frames.

FIG. 5 shows computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for the MAC address rotation as described above with respect to FIGS. 2-4. Computing device 500, for example, may provide an operating environment for controller 105, first AP 120, second AP 125, third AP 130, first client device 135, second client device 140, third client device 145, and fourth client device 150. Controller 105, first AP 120, second AP 125, third AP 130, first client device 135, second client device 140, third client device 145, and fourth client device 150 may operate in other environments and are not limited to computing device 500.

Computing device 500 may be implemented as a Wi-Fi AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
associating, by an access point, with a station using a first MAC address;
receiving, by the access point, an indication from the station that the station supports media access control address change during association;
initiating, by the access point, the media access control address change;
receiving, by the access point, a first upstream packet from the station using a second media access control address; and
sending, by the access point, a first downstream traffic to the second media access control address.

2. The method of claim 1, wherein initiating the media access control address change comprises:
providing a frame sequence number to the station; and
providing a seed for an orthogonal frequency-division multiplexing physical scrambler to the station, wherein the station uses the frame sequence number and the seed for the orthogonal frequency-division multiplexing physical scrambler for all packets with the second media access control address.

3. The method of claim 1, wherein the station generates the second media access control address using a pairwise master key.

4. The method of claim 1, wherein the access point generates the second media access control address further using pairwise master key.

5. The method of claim 1, further comprising:
sending an action frame to the station, the action frame comprising an indication of a point of transition from the first media access control address to the second media access control address.

6. The method of claim 5, wherein the point of transition is indicated in a number of frames or a time from a current frame.

7. The method of claim 1, wherein initiating the media access control address change comprises:
initiating the media access control address change for a plurality of stations associated with the access point at a same time.

8. The method of claim 1, wherein initiating the media access control address change comprises:
notifying a plurality of stations associated with the access point of the media access control address change;
receiving a block acknowledgment from the plurality of stations indicating readiness of the plurality of stations for the media access control address change; and
initiating the media access control address change for at least a portion of the plurality of stations based on the block acknowledgment.

9. The method of claim 1, further comprising:
generating, by the access point, the second media access control address; and
generating, by the station, the second media access control address.

10. A system comprising:
a memory storage; and
a processing unit, the processing unit disposed in a station and coupled to the memory storage, wherein the processing unit is operative to:
associate with a station using a first MAC address;
receive an indication from the station that the station supports media access control address change during association;
initiate the media access control address change;
receive a first upstream packet from the station using a second media access control address; and
send a first downstream traffic to the second media access control address.

11. The system of claim 10, wherein the processing unit being operative to initiate the media access control address change comprises the processing unit being operative to:
provide a frame sequence number to the station; and
provide a seed for an orthogonal frequency-division multiplexing physical scrambler to the station, wherein the station uses the frame sequence number and the seed for the orthogonal frequency-division multiplexing physical scrambler for all packets that also use the second media access control address.

12. The system of claim 10, wherein the second media access control address is generated further using a pairwise master key.

13. The system of claim 10, wherein the second media access control address further using a key encryption key.

14. The system of claim 10, wherein the processing unit is further operative to send an action frame to the station, the action frame comprising an indication of a point of transition from the first media access control address to the second media access control address.

15. The system of claim 14, wherein the point of transition is indicated in a number of frames or a time.

16. The system of claim 10, wherein the processing unit being operative to initiate the media access control address change comprises the processing unit being operative to:
initiate the media access control address change for a plurality of stations associated with the access point at a same time.

17. The system of claim 10, wherein the processing unit being operative to initiate the media access control address change comprises the processing unit being operative to:
notify a plurality of stations associated with the access point of the media access control address change;
receive a block acknowledgment from the plurality of stations indicating readiness of the plurality of stations for the media access control address change; and
initiate the media access control address change for at least a portion of the plurality of stations based on the block acknowledgment.

18. A computer-readable medium that stores a set of instructions which when executed perform a method executed by the set of instructions comprising:
associating, by an access point, with a station using a first MAC address;
receiving, by the access point, an indication from the station that the station supports media access control address change during association;
initiating, by the access point, the media access control address change;
receiving, by the access point, a first upstream packet from the station using a second media access control address; and
sending, by the access point, a first downstream traffic to the second media access control address.

19. The computer-readable medium of claim 18, wherein initiating the media access control address change comprises:
notifying a plurality of stations associated with the access point of the media access control address change;
receiving a block acknowledgment from the plurality of stations indicating readiness of the plurality of stations for the media access control address change; and
initiating the media access control address change for at least a portion of the plurality of stations based on the block acknowledgment.

20. The computer-readable medium of claim 18, further comprising sending an action frame to the station, the action frame comprising an indication of a point of transition from the first media access control address to the second media access control address.
